(19) United States
(12) Patent Application Publication
(10) Pub. No.: US 2020/0400273 A1
(43) Pub. Date: Dec. 24, 2020

(54) CONTAINER TRACKING DEVICE MOUNTING ASSEMBLY

(71) Applicant: SANDBOX LOGISTICS, LLC, HOUSTON, TX (US)

(72) Inventor: Jason Smeak, Denver, CO (US)

(21) Appl. No.: 16/448,833

(22) Filed: Jun. 21, 2019

(51) Int. Cl. F16M 13/02

(52) U.S. Cl. CPC F16M 13/025; B65D 88/022

(57) ABSTRACT

A bulk material shipping container including a W-shaped corner member, a container tracking device mounting assembly, and a container tracking device. The container tracking device mounting assembly is mounted within a cavity defined by the W-shaped corner member. The container tracking device mounting assembly includes a first mounting bracket with a first orientation and a second mounting bracket with a second opposite orientation adjacent to the first mounting bracket. The container tracking device determines autonomous geo-spatial positioning, and is mounted within a slot of the first mounting bracket and a slot of the second mounting bracket.

### BACKGROUND

Various containers such as bulk material shipping containers are known. Various known material containers are used to transport a wide range of products, parts, components, items, and other materials such as, but not limited to, seeds, shavings, fasteners, dry bulk, plastic resins, and granular materials (such as but not limited to cement or sand). These are sometimes called loose materials.

There is a continuing need for better containers such as better bulk material shipping containers and better systems for tracking such containers during loading, unloading, transport and storage.

### SUMMARY

Various embodiments of the present disclosure provide a container tracking device mounting assembly, a bulk material shipping container including a container tracking device mounting assembly, and a bulk material shipping container including a container tracking device mounting assembly and a tracking device held by the tracking device mounting assembly. In various such embodiments, the container is a bulk material shipping container; but it should be appreciated that other suitable container may be employed in accordance with the present disclosure.

Various embodiments of the container tracking device mounting assembly of the present disclosure include: (1) a first mounting bracket configured to be connected to a container; and (2) a second mounting bracket configured to be connected to the container adjacent to first mounting bracket. In various embodiments of the present disclosure, the first mounting bracket and the second mount bracket are configured to cooperate to hold the tracking device in a protected area of a corner assembly of the bulk material shipping container.

Additional features and advantages of the present invention are described in, and will be apparent from, the following Detailed Description of Exemplary Embodiments and the figures.

### DESCRIPTION OF THE DRAWINGS

FIG. 1 is a front perspective view of a mounting bracket of the container tracking device mounting assembly of one example embodiment of the present disclosure.

FIG. 2 is a front view of the mounting bracket of FIG. 1.

FIG. 3 is a rear view of the mounting bracket of FIG. 1.

FIG. 4 is a right view of the mounting bracket of FIG. 1.

FIG. 5 is a left view of the mounting bracket of FIG. 1.

FIG. 6 is a top view of the mounting bracket of FIG. 1.

FIG. 7 is a bottom view of the mounting bracket of FIG. 1.

FIG. 8 is a front perspective view of the container tracking device mounting assembly including two mounting brackets of FIG. 1 with opposite orientations that are adjacent to each other.

FIG. 9 is a front perspective view of the container tracking device mounting assembly of FIG. 8 with the container tracking device held or locked into place by the pair of mounting brackets.

FIG. 10 is a front perspective view of the container tracking device mounting assembly of FIG. 8 with the container tracking device locked into place installed on a bulk material shipping container.

FIG. 11 is an enlarged exploded perspective view of the container tracking device mounting assembly of FIG. 8 and the container tracking device relative to a corner assembly (shown in fragmentary) of the bulk material shipping container (shown in fragmentary).

FIG. 12 is an enlarged perspective view of the container tracking device mounting assembly of FIG. 8 with the container tracking device locked into place installed on the corner assembly (shown in fragmentary) of the bulk material shipping container (shown in fragmentary).

### DETAILED DESCRIPTION OF EXEMPLARY EMBODIMENTS

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

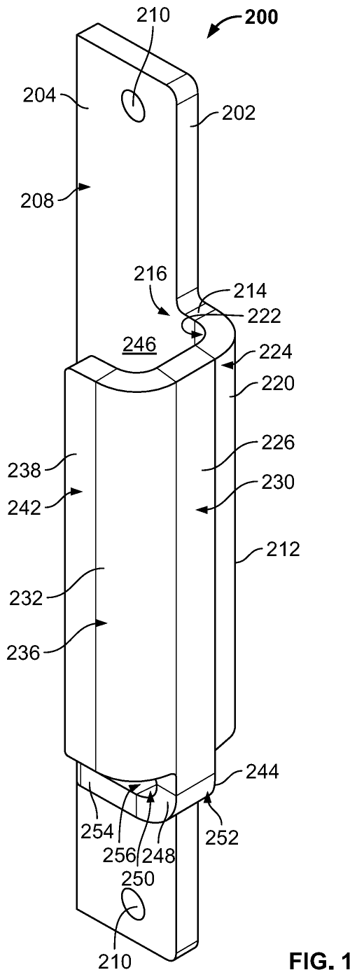

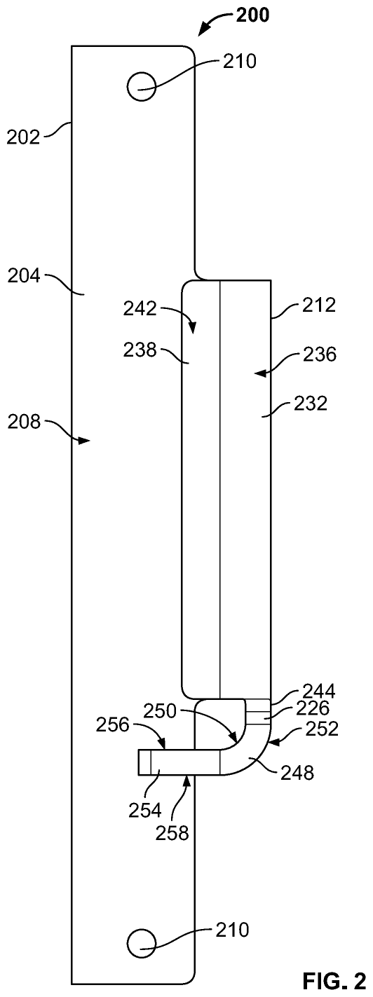

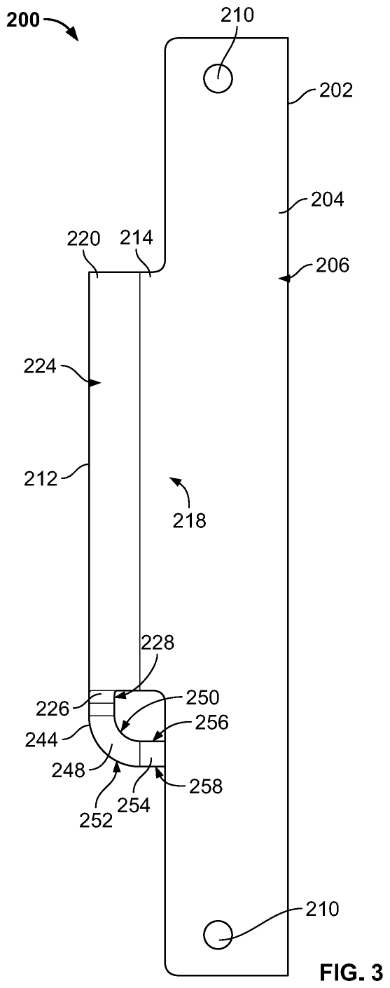

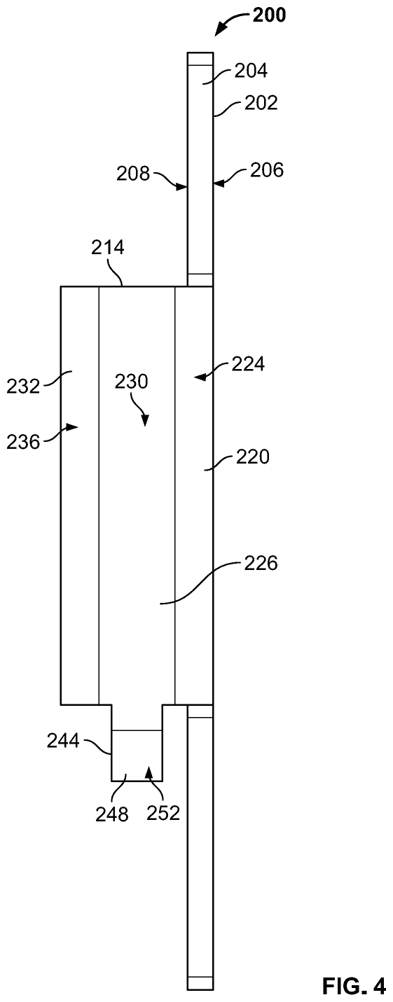

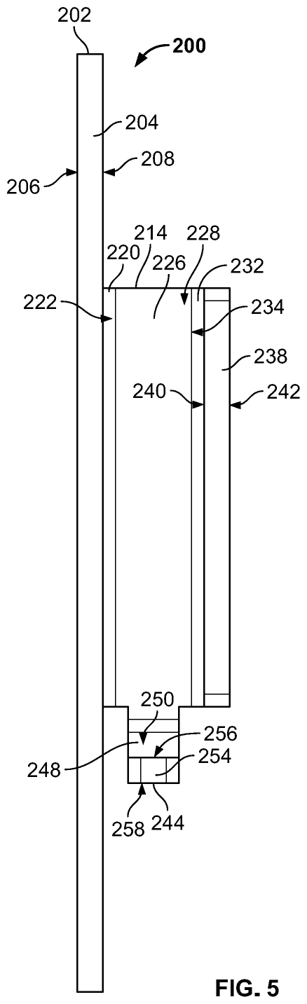

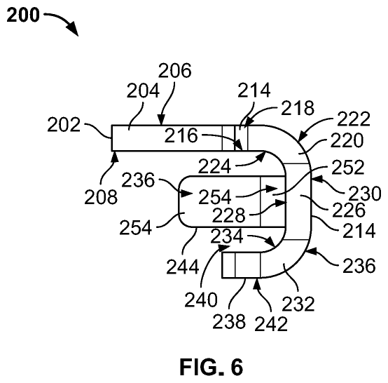

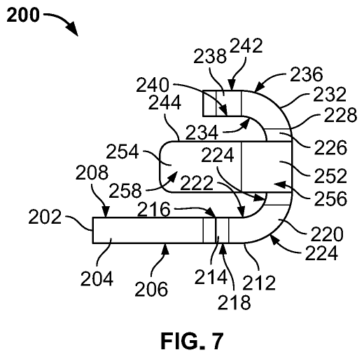

Referring now to the drawings, FIGS. 1 to 12 illustrate one example embodiment of the container tracking device mounting assembly of the present disclosure. This example container tracking device mounting assembly, which is generally indicated by numeral 100, is configured to be securely attached to a bulk material shipping container 105 (for simplicity, sometimes referred to as “the container”) and to receive and securely hold a container tracking device 110.

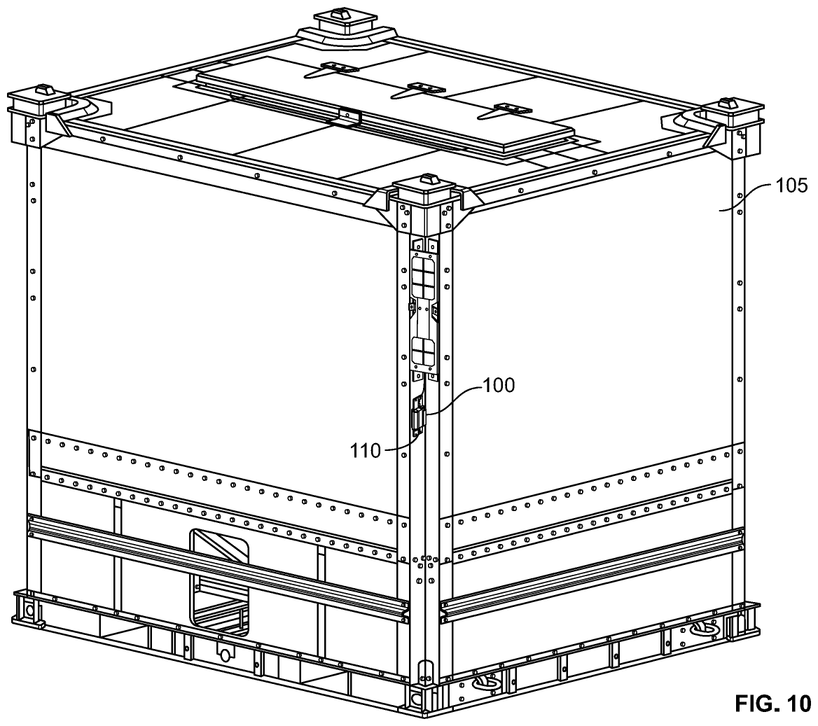

Generally, in this illustrated example embodiment, the container tracking device mounting assembly 100 includes: (1) a first mounting bracket 200 configured to be connected to a container 105; and (2) a second mounting bracket 300 configured to be connected to the container 105 adjacent to first mounting bracket 200. It should be appreciated that the container tracking device mounting assembly 100 including each of the first mounting bracket 200 and the second mounting bracket 300 are configured to shield the tracking device to ensure it is oilfield rugged. The container tracking device mounting assembly protects the front and the sides of the tracking device from impacts as most commonly seen in its location on the container as shown in FIGS. 10, 11, and 12, while not impacting the signal or sensor functionality of the tracking device as further explained below.

As best illustrated in FIGS. 1 to 9, the first mounting bracket 200 includes: (1) a mounting base 202; and (2) a device holder 212 connected to and protruding from the mounting base 202.

The mounting base 202 includes a wall 204 having: (1) a container engagement surface 206; and (2) a device engagement surface 208. The wall 204 of the mounting base defines two mounting holes 210 to facilitate mounting the first mounting bracket 200 to the container 105. The mounting holes 210 are defined in the wall 204 such that when the orientation of the first mounting bracket 200 is reversed, the mounting holes 210 are in the same relative locations or heights.

The device holder 212 includes: (1) a connecting segment 214 having a device engagement surface 216 and an outer surface 218; (2) an inner transition segment 220 having a device engagement surface 222 and an outer surface 224; (3) a middle segment 226 having a device engagement surface 228 and an outer surface 230; (3) an outer transition segment 232 having a device engagement surface 234 and an outer surface 236; (4) an end segment 238 having a device engagement surface 240 and an outer surface 242; and (5) a locking arm 244 connected to and protruding from the middle segment 226.

The connecting segment 214, the inner transition segment 220, the middle segment 226, the outer transition segment 232, and the end segment 238 define a slot 246 configured to receive the container tracking device 110. The device engagement surface 216 of the connecting segment 214, the device engagement surface 222 of the inner transition segment 220, the device engagement surface 228 of the middle segment 226, the device engagement surface 234 of the outer transition segment 232, and the device engagement surface 240 of the end segment 238 form a unified engagement surface configured to engage the container tracking device 110 when the container tracking device 110 is within the slot 246.

The device engagement surface 216 of the connecting segment 214 is coplanar with the device engagement surface 208 of the wall 204 of the mounting base 202. The inner transition segment 220 and the outer transition segment 232 are bent or curved so that a plane defined by the device engagement surface 240 of the end segment 238 is parallel to a plane defined by the device engagement surface 216 of the connecting segment 214. The plane defined by the device engagement surface 228 of the middle segment 226 is transverse (and particularly perpendicular) to the plane defined by the device engagement surface 216 of the connecting segment 214.

The locking arm 244 includes: (1) a transition segment 248 having a device engagement surface 250 and an outer surface 252; and (2) a support arm 254 having a device engagement surface 256 and an outer surface 258. The locking arm 244 is configured to engage the container tracking device 110 when the container tracking device 110 is within the slot 246. The transition segment 248 is bent or curved so that the plane defined by the device engagement surface 256 of the support arm 254 is transverse (and particularly perpendicular) to planes defined by the unified device engagement surface. That is, the transition segment 248 is curved such that the support arm 254 protrudes into and defines the slot 246. The locking arm 244 is configured to be adjusted (upwardly or downwardly) to tightly or securely hold the tracking device in place during and after installation. It should also be appreciated that the locking arm is configured to hold the tracking device without blocking the bottom or top of the tracking device and thus does not block features of the tracking device such as the light sensor(s) and USB charging port and/or power port.

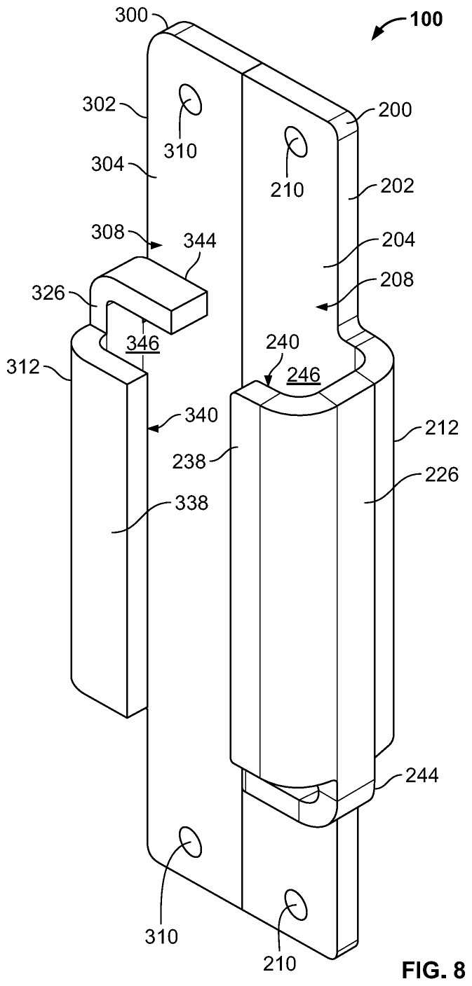

The second mounting bracket 300 is identical to the first mounting bracket 200. As best shown in FIGS. 8, 9, and 10, when formed into the container tracking device mounting assembly 100: (a) the second mounting bracket 300 is adjacent to the first mounting bracket 200; and (b) the first mounting bracket 200 has a first orientation and the second mounting bracket has a second different orientation. The first orientation is rotated 180 degrees with respect to the second orientation (e.g., they are opposite orientations). When the first mounting bracket 200 and the second mounting bracket 300 are positioned together, the device engagement surface 208 of the wall 204 of mounting base 202 of the first mounting bracket 200 is coplanar with the device engagement surface 308 of the wall 304 of the mounting base 302 of the second mounting bracket 300. It should be appreciated that this facilitates: (1) the simplification of inventory by providing only one SKU; (2) easier maintenance and replacement procedures; (3) rapid production; and (4) very efficient use of material.

In various embodiments, the container tracking device mounting assembly 100 including each of the first and second mounting brackets 200 and 300 are suitably formed from relatively strong aluminum (such as but not limited to a clad 2014 aluminum alloy, a 2024 aluminum alloy, or a 5052 aluminum alloy, etc.) that causes less signal interference to a satellite receiver of the container tracking device 110. This is in addition to additive with the configuration of the brackets that as mentioned above minimize impact on the signals outputted by and the sensor(s) of the tracking device. It should be appreciated that one or more of the first and second mounting brackets can be made from one or more other suitably strong materials in accordance with the present disclosure. It should also be appreciated that one or more of the first and second mounting brackets can be otherwise suitably configured in accordance with the present disclosure.

In various embodiments, the container tracking device mounting assembly 100 is configured to mount the container tracking device 110 to a bulk material shipping container 105 such as the bulk material shipping container described in U.S. Pat. No. 8,887,914 and U.S. Published Patent Application No. 2018/0002066 which are incorporated herein by reference. Thus, as mentioned above, in various embodiments, the present disclosure provides such a bulk material shipping container with the container tracking device mounting assembly of the present disclosure, and in various further embodiments with a container tracking device held by the container tracking device mounting assembly of the present disclosure.

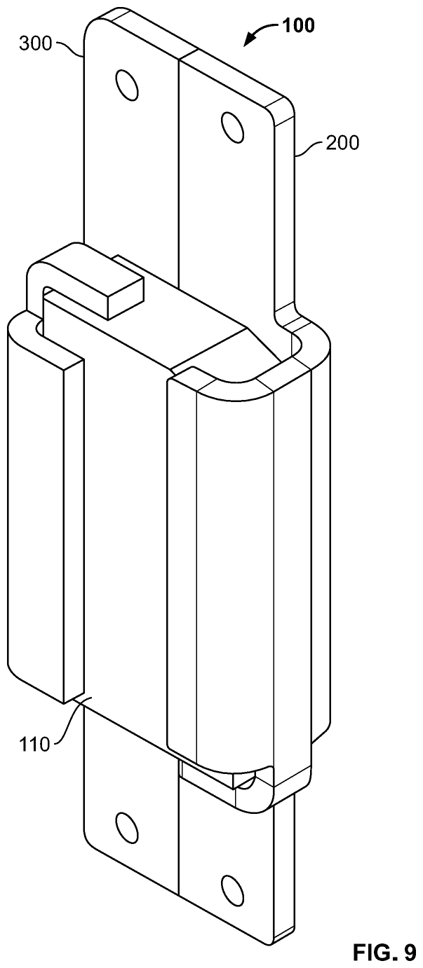

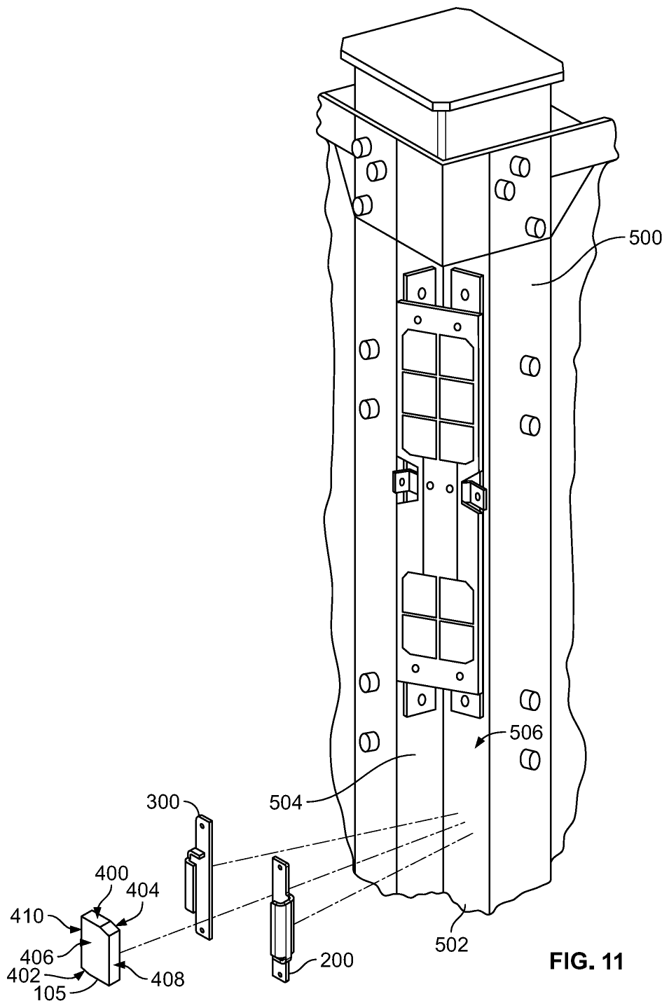

In this illustrated embodiment, the container tracking device 110 includes a global navigation satellite system (GNSS) receiver (e.g., a global positioning system (GPS) receiver, a Global Navigation Satellite System (GLONASS) receiver, Galileo Positioning System receiver, BeiDou Navigation Satellite System receiver, etc.) that provides autonomous geo-spatial positioning (e.g., longitude, latitude, and altitude/elevation). As best illustrated in FIG. 11, the container tracking device 110 has a top surface 400, a bottom surface 402, an inner surface 404, an outer surface 406, a right surface 408, and a left surface 410. As best illustrated in FIGS. 9 to 12, when held or locked into the container tracking device mounting assembly 100: (a) the top surface 400 engages a device engagement surface 350 of a locking arm 344 of the second mounting bracket 300; (b) a bottom surface 402 engages the device engagement surface 250 of the locking arm 244 of the first mounting bracket 200; (c) the inner surface 404 engages the device engagement surface 208 of the wall 204 of mounting base 202 of the first mounting bracket 200 and the device engagement surface 308 of the wall 304 of the mounting base 302 of the second mounting bracket 300; (d) the outer surface 406 engages the device engagement surface 240 of the end segment 238 of the device holder 212 of the first mounting bracket 200 and device engagement surface 340 of the end segment 338 of the device holder 312 of the second mounting bracket 300; (e) the right surface 408 engages the device engagement surface 228 of the middle segment 226 of the device holder 212 of the first mounting bracket 200; and (f) the left surface 410 engages the device engagement surface 328 of the middle segment 326 of the device holder 312 of the second mounting bracket 300.

The container tracking device mounting assembly 100 is configured to: (a) use a minimum amount of aluminum to minimize the signal interference between the GNSS receiver of the container tracking device 110 and the GNSS satellites, while (b) suitably securing and protecting the container tracking device 110 in an industrial environment (such as but not limited to an fracking oil field environment). The device holder 212 of the first mounting bracket 200 and the device holder 312 of the second mounting bracket 300 are configured to cover only a portion of the top surface 400, the bottom surface 402, and the outer surface 406 of the container tracking device 110. The outer transition segment 232 and the end segment 238 of the first mounting bracket 200 are configured to cover no more than 25 percent of the outer surface 406 (such as 12.5 percent to 25 percent of the outer surface 406). The locking arm 244 of the first mounting bracket 200 is configured to cover no more than 50 percent of the top surface 400 or the bottom surface 402 (such as 25 percent to 50 percent of the top surface 400 or the bottom surface 402). Because the second mounting bracket 300 is identical the first mounting bracket 200, the corresponding segments of the second mounting bracket 300 are identically configured.

As best illustrated in FIGS. 10, 11, and 12, the bulk material shipping container 105 includes upright corner assemblies 500 with elongated vertically extending upright W-shaped corner members 502. The elongated vertically extending upright W-shaped corner member 502 defines a cavity 504. When installed, the container tracking device mounting assembly 100 is mounted within the area, pocket or cavity 504 via the mounting holes 210 and 310 so that the container tracking device mounting assembly 100 is protected while the bulk material shipping container 105 is in use.

As best illustrated in FIGS. 10, 11, and 12, the bulk material shipping container 105 includes the container tracking device mounting assembly 100. The container tracking device mounting assembly 100 is mounted on the bulk material shipping container 105: (a) the first mounting bracket 200 is mounted having the first orientation on a surface 506 of the one of the W-shaped corner members 502; and (b) the second mounting bracket 300 is mounted having the second opposite orientation on the surface 506 adjacent to the first mounting bracket 200. The first mounting bracket 200 and the second mounting bracket 300 are position on the surface 206 so that the first mounting bracket 200 and the second mounting bracket 300 are entirely within the cavity 504.

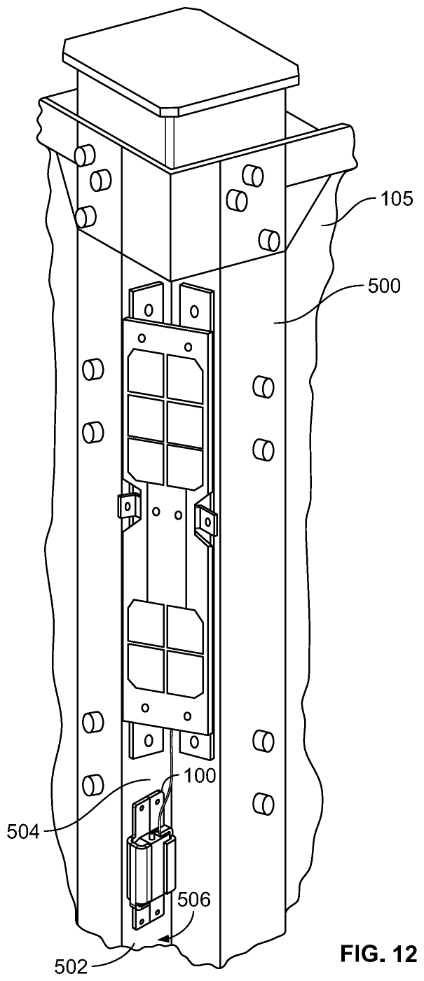

As best illustrated in FIG. 12, the bulk material shipping container 105 includes: (1) the container tracking device mounting assembly 100; and (2) the container tracking device 110. The container tracking device mounting assembly 100 and the container tracking device 110 are mounted on the bulk material shipping container 105: (a) the first mounting bracket 200 is mounted having the first orientation on the surface 506 of the one of the W-shaped corner members 502; (b) the second mounting bracket 300 is mounted having the second opposite orientation on the surface 506 adjacent to the first mounting bracket 200; and (c) the container tracking device 110 is within the slot 246 defined by the first mounting bracket 200 and the slot 346 defined by the second mounting bracket 300. The container tracking device 110 engages the device holder 212 of the first mounting bracket 200 and the device holder 312 of the second mounting bracket. The first mounting bracket 200 and the second mounting bracket 300 are position on the surface 206 so that the first mounting bracket 200, the second mounting bracket 300, and the container tracking device 110 are entirely within the area, pocket or cavity 504.

It should further be appreciated that the attachment of the assembly to the container can be performed in any suitable way such as by welding (including but not limited to laser welding) and/or by suitable fasteners (such as but not limited to rivets and bolts and nuts).

It should be appreciated that the present disclosure contemplates the elimination or reduction of sharp edges in the assembly and that any sharp edges can be curved or formed with a suitable radius.

It should be understood that modifications and variations may be effected without departing from the scope of the novel concepts of the present disclosure, and it should be understood that this application is to be limited only by the scope of the appended claims.

The invention is claimed as follows:

1. A container tracking device mounting assembly comprising:
a first mounting bracket with a first orientation; and
a second mounting bracket with a second orientation adjacent to the first mounting bracket;
each of the first and second mounting brackets including:
(1) a mounting base; and
(2) a device holder connected to and protruding from the mounting base, the device holder defining a slot configured to receive a container tracking device.

2. The container tracking device mounting assembly of claim 1, wherein the device holder includes: (1) a connecting segment connected to the mounting base; (2) a curved inner transition segment; (3) a middle segment; (4) a curved outer transition segment; and (5) an end segment, wherein the connecting segment, curved inner transition segment, the middle segment, the curved outer transition segment, and the end segment define the slot.

3. The container tracking device mounting assembly of claim 1, wherein the device holder includes a locking arm configured to engage the container tracking device when the container tracking device is in the slot, the locking arm being sized to cover no more than fifty percent of a corresponding surface of the container tracking device.

4. The container tracking device mounting assembly of claim 3, wherein the locking arm includes: (1) a curved transition segment; and (2) a support arm.

5. The container tracking device mounting assembly of claim 1, wherein the device holder includes: (1) a connecting segment connected to the mounting base; (2) a curved inner transition segment; (3) a middle segment; (4) a curved outer transition segment; and (5) an end segment, the curved outer transition segment and the end segment being sized to cover no more than twenty-five percent of a front surface of the container tracking device.

6. The container tracking device mounting assembly of claim 5, wherein the device holder includes a locking arm with a curved transition segment and a support arm.

7. The container tracking device mounting assembly of claim 6, wherein the curved transition segment of the locking arm is curved so a first plane defined by a first surface of the support arm transverses a second plane defined by a second surface of the middle segment.

8. A bulk material shipping container comprising:
a W-shaped corner member defining a cavity; and
a container tracking device mounting assembly mounted within the cavity, wherein the container tracking device mounting assembly includes:
(a) a first mounting bracket with a first orientation; and
(b) a second mounting bracket with a second orientation adjacent to the first mounting bracket;
each of the first and second mounting brackets including:
(i) a mounting base; and
(ii) a device holder connected to and protruding from the mounting base, the device holder defining a slot configured to receive a container tracking device.

9. The bulk material shipping container of claim 8, wherein the container tracking device mounting assembly is mounted entirely within the cavity.

10. The bulk material shipping container of claim 8, wherein the device holder includes: (1) a connecting segment connected to the mounting base; (2) a curved inner transition segment; (3) a middle segment; (4) a curved outer transition segment; and (5) an end segment, wherein the connecting segment, curved inner transition segment, the middle segment, the curved outer transition segment, and the end segment define the slot.

11. The bulk material shipping container of claim 8, wherein the device holder includes a locking arm configured to engage the container tracking device when the container tracking device is in the slot.

12. The bulk material shipping container of claim 11, wherein the locking arm includes: (1) a curved transition segment; and (2) a support arm.

13. The bulk material shipping container of claim 8, wherein the device holder includes: (1) a connecting segment connected to the mounting base; (2) a curved inner transition segment; (3) a middle segment; (4) a curved outer transition segment; and (5) an end segment.

14. The bulk material shipping container of claim 13, wherein the device holder includes a locking arm with a curved transition segment and a support arm.

15. The bulk material shipping container of claim 14, wherein the curved transition segment of the locking arm is curved so a first plane defined by a first surface of the support arm transverses a second plane defined by a second surface of the middle segment.

16. A bulk material shipping container comprising:
a W-shaped corner member;
a container tracking device mounting assembly mounted entirely within a cavity defined by the W-shaped corner member, the container tracking device mounting assembly including:
(a) a first mounting bracket with a first orientation; and
(b) a second mounting bracket with a second orientation adjacent to the first mounting bracket;
each of the first and second mounting brackets including:
(i) a mounting base; and
(ii) a device holder connected to and protruding from the mounting base, the device holder defining a slot configured to receive a container tracking device; and
(3) the container tracking device configured to determine autonomous geo-spatial positioning, wherein the container tracking device is mounted within the slot of the first mounting bracket and the slot of the second mounting bracket.

17. The bulk material shipping container of claim 16, wherein the device holder includes: (1) a connecting segment connected to the mounting base; (2) a curved inner transition segment; (3) a middle segment; (4) a curved outer transition segment; and (5) an end segment, wherein the connecting segment, curved inner transition segment, the middle segment, the curved outer transition segment, and the end segment define the slot.

18. The bulk material shipping container of claim 17, wherein the device holder includes a locking arm configured to engage the container tracking device when the container tracking device is in the slot.

19. The bulk material shipping container of claim 18, wherein the locking arm includes: (1) a curved transition segment; and (2) a support arm.

20. The bulk material shipping container of claim 19, wherein the curved transition segment of the locking arm is curved so a first plane defined by a first surface of the support arm transverses a second plane defined by a second surface of the middle segment.
